(19) United States
(12) Patent Application Publication
(10) Pub. No.: US 2002/0182110 A1
(43) Pub. Date: Dec. 5, 2002

(54) Device and method for analysing body fluids

(76) Inventor: Holger Behnk, Hamburg (DE)

Correspondence Address: ALIX YALE & RISTAS LLP, 750 MAIN STREET, SUITE 1400, HARTFORD, CT, 06103, US

(21) Appl. No.: 10/157,284

(22) Filed: May 29, 2002

(30) Foreign Application Priority Data
May 30, 2001 (EP) 01 113 182.8

(51) Int. Cl. G01N 9/30

(52) U.S. Cl. 422/72; 422/82.05; 422/82.09; 422/102; 436/45; 436/149; 436/164; 436/165

(57) ABSTRACT

The device for analysing body fluids, having a plurality of cuvettes (1), is distinguished in that the cuvettes (1) are connected to one another in a circular arrangement, and respectively have a holding space (2) for the reagent with a bottom rising radially outwards, which is followed radially outwards by the reaction chamber (4). The reagent is delivered by centrifugal force from the holding chamber (2) into the reaction chamber (4), where it reacts with the fluid to be analysed, and this is detected by sensors (8, 10).

The invention relates to a device for analysing body fluids and to an arrangement of a plurality of cuvettes which can be fitted into the device, into which the body fluid to be analysed and a reagent can be introduced separately and can be brought together in a reaction chamber after the incubation time has elapsed, wherein a stirrer made of magnetically attractable material is arranged in each reaction chamber, and can be set in motion by a magnet, and having at least one measuring station. The invention also relates to a method and to a cuvette arrangement for analysing body fluids.

In a device of the type mentioned in the introduction (EP 0 369 16B B1), a plurality of cuvettes are combined to form a linear arrangement, which is provided with a gear rack. The reagent and body fluid are introduced separately, and are brought together by tilting the arrangement. The measurements can subsequently be carried out, the arrangement of cuvettes being moved to one or measuring stations with the aid of the gear rack.

This device has the disadvantage, however, that the cuvettes need to be substantially closed at the top, so that the liquids cannot leak out after the tilting required for combining them. It will also normally be necessary to make the gear rack and the cuvettes from different materials, so that these arrangements are comparatively expensive. This is even more so since they cannot be made by a single injection-moulding process, because the cuvettes are substantially closed. The corresponding extra costs turn out to be particularly significant since these cuvettes are disposable articles intended for single use. Although it is possible to carry out measurements simultaneously on a plurality of samples, it is then necessary to provide a separate measuring station for each cuvette. Furthermore, measurements with different wavelengths on the same cuvette at the same time are not possible.

It is an object of the invention to provide a device, a method and a cuvette arrangement which are more economical and which make it possible to carry out multiple measurements in a more straightforward and more reliable way.

The inventive solution consists, on the one hand in a device, in that the cuvettes are connected to one another in a circular arrangement, and respectively have a holding space for the reagent with a bottom rising radially outwards, in that the reaction chamber is arranged radially outwards from the holding space, and extends in the axial direction to a greater depth than the holding space, in that the cuvette arrangement can be rotated about its axis with the aid of a rotor, and in that the device has a magnet at the circumference of the fitted arrangement of cuvettes, and which has at least one measuring station.

The method for operating this device is distinguished in that at least one of the cuvettes is filled with reagent and body fluid, the cuvette arrangement is fitted into the device and, with the aid of the rotor, a rotation through at least 360° is carried out in order to identify samples which have been measured previously and/or samples which are to be measured, the cuvettes with the reagents and samples are incubated, the reagents are taken into the reaction chambers by subsequent rapid rotation of the cuvette arrangement, and the optical and/or magnetic measurements are subsequently carried out.

A cuvette arrangement according to the invention for analysing body fluids, having a plurality of cuvettes, is distinguished in that the cuvettes are connected to one another in a circular arrangement, and respectively have a holding space for the reagent with a bottom rising radially outwards, and the reaction chamber is arranged radially outwards from the holding space and extends in the axial direction to a greater depth than the holding space.

The invention therefore departs from the linear arrangement of cuvettes. Instead, the cuvettes are arranged in a circle. In this case, it is naturally no longer possible to tilt the arrangement in order to combine the reagent and body fluid, since the desired combination at the desired position could then only take place on one side. Instead, the combination takes place through centrifugal force, by setting the cuvette arrangement in rotation. The reagent and the body fluid to be analysed are in this case combined in reaction chambers which extend axially to a greater depth than the holding space for the reagent. Because of this greater depth, and since the arrangement does not need to be tilted in contrast to the arrangement of the part, both the holding spaces for the reagents and the reaction spaces, into which the fluids are introduced, can be open at the top. The cuvette arrangements can therefore be made by injection moulding, with straightforward mould release being possible.

It is known to arrange cuvettes in a circle and to move the reagents outwards by centrifugal force (U.S. Pat. No. 4,226,531 A). The device of the invention has the advantage over this that the reaction chamber is comparatively deep, so that the sample to be analysed and the reagent cannot be ejected, without it being necessary to use a lid as in the prior art On the one hand, this lid renders manufacture more complicated, since two parts needed to be made by injection moulding and welded to one another (last paragraph on page 5 of U.S. Pat. No. 4,226,531 A). The cuvette arrangements according to the invention can be made completely by a single injection-moulding process. If the walls of the cuvettes are designed so that they diverge slightly outwards, then the cuvettes can not only be easily removed from the mould, but can also be stacked in one another to save space. This stacking in one another can also hold the magnetic stirrers in place, so that they do not become lost. This entails significant savings on space and on packaging costs.

Another difference is that the rotor cuvette of U.S. Pat. No. 4,226,531 A is intended to be fitted into a centrifugal analyser. In such a system, the rotation speed is many times higher than in the device of the present invention. Owing to the high centrifugal force, it is not possible to carry out determination with a reagent which contains suspended particles, for example determination of APTT with a kaolin-activated reagent.

The measuring cells are horizontally arranged, in contrast to the device of the invention. A high rotation speed is needed in order to fill the horizontally lying measuring cells with the sample. Centrifugal analysers are generally operated only with appropriately matched reagents, and are therefore unsuitable either for whole blood measurements or for unmatched reagents,

Another substantial difference from the aforementioned prior art of U.S. Pat. No. 4,226,531 A, as well as from the further prior art of U.S. Pat. No. 4,309,384 A, involves the stirrer which is found in the reaction chamber. On one hand, this stirrer thoroughly mixes the mixture of the sample and the reagent. The way in which this thorough mixing might be carried out in the device of U.S. Pat. No. 4,226,531 is not clear. Possibly, this is achieved by high and alternating rotation speeds, in which case the cover then needs to be provided in order to prevent ejection. In the prior art of U.S. Pat. No. 4,309,384, the rotation speed needs to be increased and decreased repeatedly, so that the reagent found in the space 52 can rise to the region 50 and flow back down, so as to flush down the sample found at 50 (column 5, 1st paragraph of the citation). A defined time for the start of the reaction is not provided in this case.

The magnetic stirrer is not only employed for better mixing. Rather, the motion of the stirrer draws clots together in such a way that a very large turbidity difference is created, which can be optically measured better than if the turbidity occurred throughout the reaction volume. Furthermore, if not only an optical sensor as in the prior art, but also a magnetic sensor is provided, a measurement can also be carried out with non-transparent fluids, for example blood.

The reagent and the body fluid should not be incubated, that is to say typically warmed to a temperature of 37° C., until a relatively short time before the starting reaction. With the device according to the invention, it is then unnecessary to incubate the reagent beforehand, an incubated reagent having only a comparatively short life, that is to say time within which it can be used. Instead, the reagent may be stored in a cooled fashion and can be introduced directly into the cuvettes. The body fluids can also be stored in a cooled fashion and introduced into the cuvettes. This can be done outside the measuring device, so that it is possible, for example, to fill a new cuvette arrangement while a measurement is still being carried out with a previous one. This increases the possible sample throughput. If the cuvette arrangement has twelve cuvettes, 120 seconds are allowed for the incubation, 60 seconds for the measurement process and 20 seconds for changing over the cuvette arrangements, then 216 measurements are possible per hour. A higher working speed is also possible since the cuvettes are open at the top and the fluids do not need to be put in carefully through narrow openings, as in the prior art.

Once the cuvette arrangement has been fitted into the device, then it is initially rotated once through at least 360° about its axis, so that the device can establish the cuvettes in which measurements are to be carried out or in which measurements have already been carried out previously. This process can be automated just like the subsequent measurements. For instance, the patient's identification can be entered via a keyboard or can be queried from a connected computer. The corresponding entries and checks may be carried out using one or more keys and displays.

Subsequently, for a predetermined time, for example 120 seconds, the warming of the cuvettes and fluids is carried out, which can be done through simple thermal contact of the cuvette with the rotor on which it is arranged. In this case, the cuvettes have a relatively large surface area which can come into contact with corresponding surfaces of the rotor, so that the heat exchange takes place rapidly.

After the incubation time has elapsed, the rotor and hence the cuvettes are set in rotation with a speed such that, because of the centrifugal force, the reagents enter the reaction chambers, where they are combined with the body fluid. The corresponding rotational movement is in this case started carefully and slowly, in order to avoid ejection.

When the cuvette arrangement is rotating, the cuvettes successively come into the proximity of the magnet which attracts the stirrer. This stirrer is magnetically attractable, and is advantageously a ball The motion of the ball due to the magnetic field not only stirs the mixture of reagent fluid and body fluid. In the case of a coagulation measurement, the motion of the stirrer draws clots together in such a way that a very large turbidity difference is created, which can be optically measured so that reliable identification of the coagulation is guaranteed.

On its circular path, each cuvette with the stirrer and the mixture of the reagent and the body fluid moves past not only the magnet, but also one or more measuring stations, at which primarily an optical measurement can be carried out. In this case, either reflected light or transmitted light can be measured. The measurement at different measuring stations may also take place with different wavelengths, so as to measure different parameters. Lastly, a sensor at a measuring station may also be used to detect the position of the stirrer, which no longer moves when the mixture of the reagent and the body fluid is coagulated. This makes it possible to identify the time of the coagulation even in the case of non-transparent fluids, for example blood.

Advantageously, the bottom of the reaction chambers is curved concavely in both the radial and circumferential directions. By means of this, it is possible to achieve a particularly effective mixing action, especially with a spherical stirrer. Initially, the stirrer stays at the lowest point of the bottom of the reaction chamber, that is to say in the middle. The curves are in this case so great that the ball is not significantly moved away from this position by the centrifugal force. When the ball enters the region of the magnetic field, however, it is attracted by the latter and moves upwards on the curve, so that a circular movement of the ball is initiated. At the same time, however, the ball reaches the region of the more or less vertical walls and is no longer prevented from an outward movement by the curve which increases radially outwards. Instead, the ball moves fully outwards at this location, along the corresponding outer wall, before falling back down on the opposite side and being returned to the middle of the bottom of the reaction chamber by the curves. This movement stops as soon as the fluid to be analysed is coagulated. The ball then remains at the bottom. Using a magnetic sensor, it is then possible to identify that the ball is no longer moving upwards, so as to detect that the fluid is coagulated.

Expediently, the curvatures of the two curves are different.

As already mentioned, the cuvettes are open at the top. Furthermore, all the chambers and holding spaces expediently widen slightly upwards. This has the advantage, on the one hand, that the cuvette arrangement is made by injection moulding, in which case the mould halves can readily be removed upwards and downwards after a cuvette arrangement has been manufactured. On the other hand, the cuvettes can in this way be stacked in one another. In order to prepare for measurements, a stirrer can be introduced into each of the reaction spaces and the next arrangement can be stacked on it, so that it closes the openings of the cuvette arrangement lying underneath and the balls can no longer fall out. Naturally, this can be repeated with further cuvette arrangements stacked on top. This is a preparatory operation which can be carried out irrespective of the time of subsequent measurements. Of course, the cuvettes may in this way be provided with balls and delivered stacked above one another by the manufacturer.

With the optical multi-value acquisition, the device according to the invention and the method according to the invention can be used for the determination of chromogenic substances and coagulation times of latex and blood. The coagulation measurement is in this case supported by active movement of the ball, that is to say the motion of the ball draws the clot together in such a way that a very large turbidity difference can be measured. It is, however, also possible to analyse other body fluids or other states and parameters of these body fluids.

The invention will be explained below with the aid of an advantageous embodiment and with reference to the appended drawings, in which:

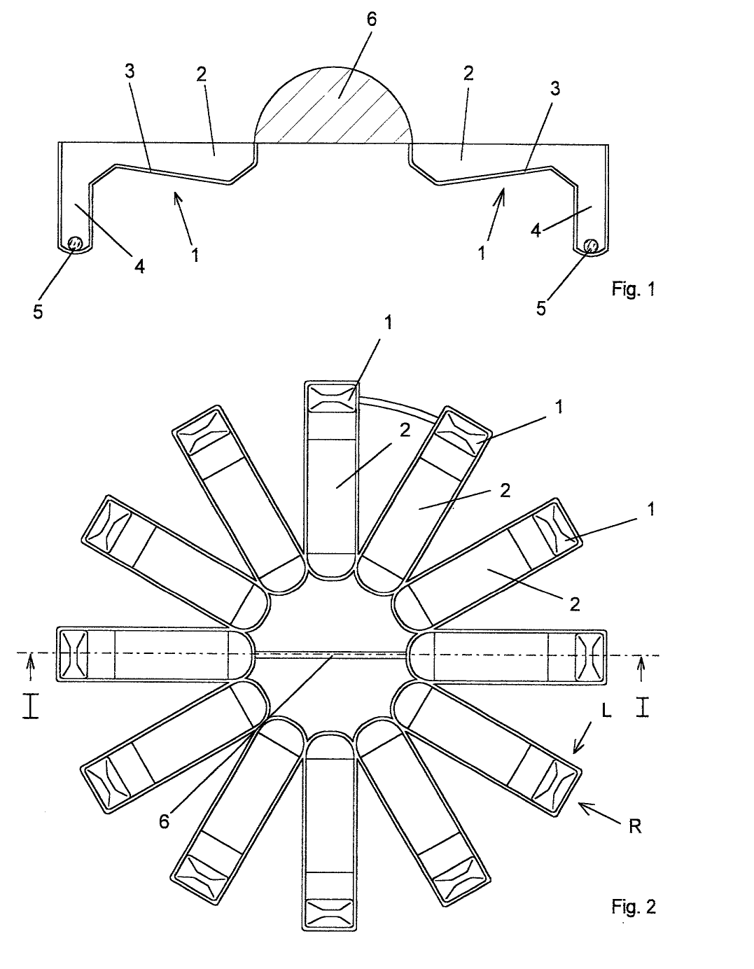

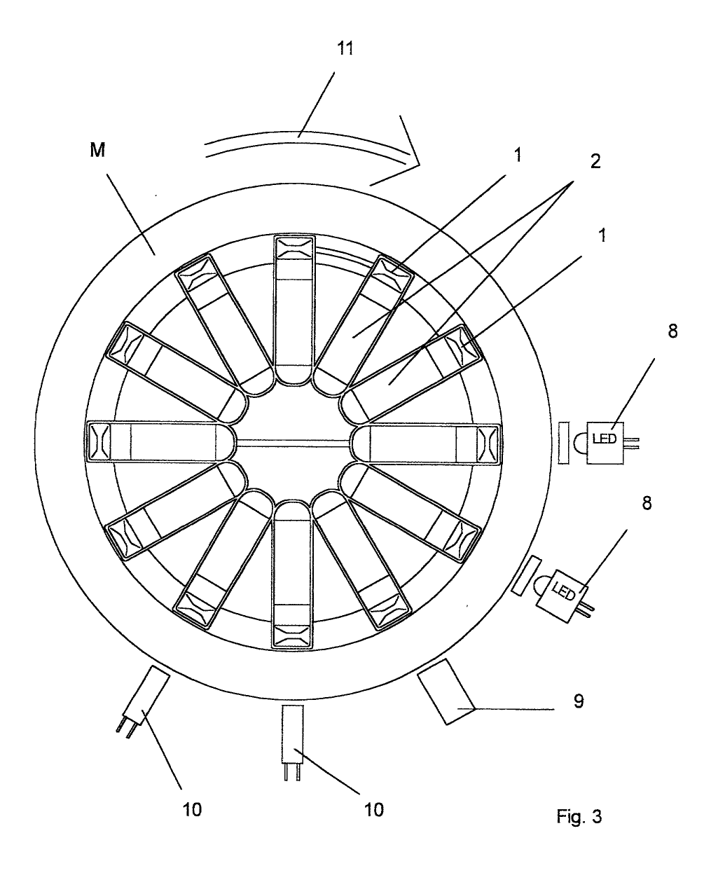

FIG. 1 shows a section through two diametrally opposite cuvettes along the line 1/1 of FIG. 2;

FIG. 2 shows the cuvette arrangement from above;

FIG. 3 shows the basic arrangement of the cuvette arrangement in a rotor having measuring stations;

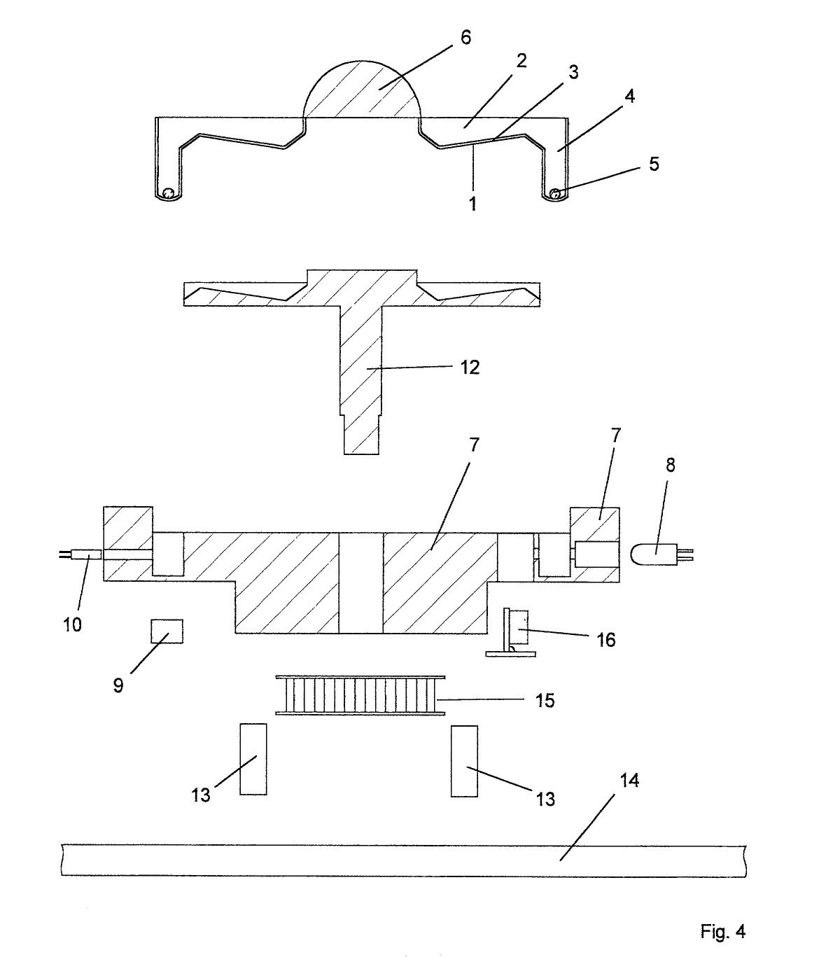

FIG. 4 shows an exploded view of the essential parts of the device according to the invention;

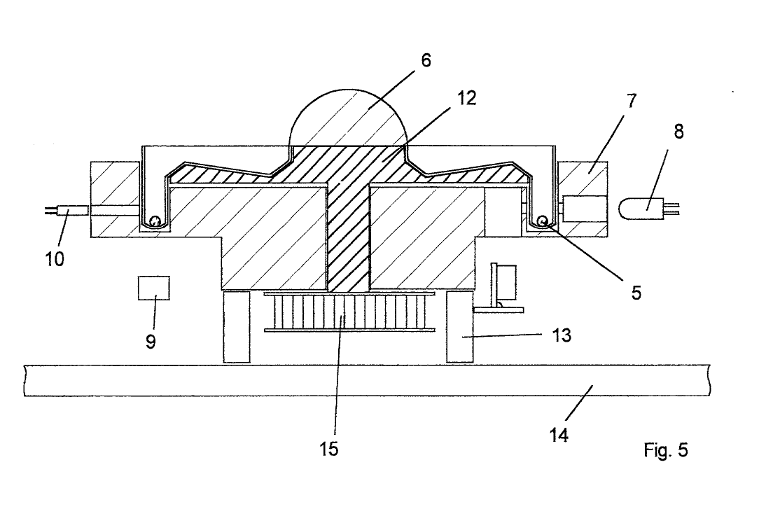

FIG. 5 shows the arrangement of FIG. 4 in the assembled state; and

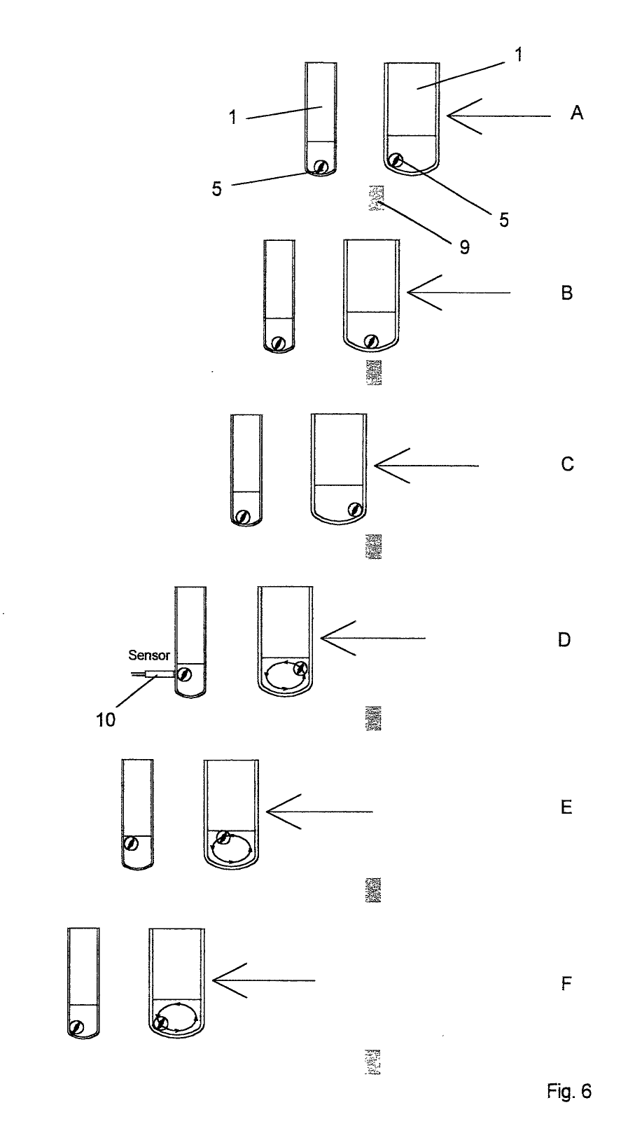

FIG. 6 shows the movement in time/space of the ball which is used as a stirrer.

As shown in FIGS. 1 and 2, the cuvette arrangement has twelve cuvettes 1, two of which are in each case arranged diametrally opposite one another. Towards the centre of the circular arrangement, there is a holding space 2 for the reagent, which has a bottom 3 rising radially outwards. This is respectively followed radially outwards by a reaction chamber 4, which extends down further than the holding space 2 in the axial direction. The reagent is introduced into the holding space 2, and the fluid to be analysed is introduced into the reaction chamber 4. In each reaction chamber 4, there is also a spherical magnetically attractable stirrer 5. A handle 6 may in this case be used to transport the arrangement and fit it into the rotor, which is denoted by 12 in FIG. 3. The handle 6 may be omitted since the arrangement can be gripped at the cuvettes. The rotor 12 is fitted into an incubator 7, on whose circumference measuring stations 8 are provided with a light-emitting diode, which have different wavelengths. A magnet 9, using which the stirrer 5 is moved, is arranged at another location. The position of this magnetic stirrer can be detected using sensors 10. The rotor 12 and the arrangement of cuvettes rotate in the direction of the arrow 11 during the measurement.

FIG. 4 shows an exploded view of the arrangement according to the invention. The circular arrangement of cuvettes 1 is placed on the rotor 12, the upper surface of which is well matched to the lower surface of the arrangement of cuvettes 1, so that good thermal contact occurs here, This rotor 12 is fitted into the incubator 7, which is fastened to a base plate 14 with the aid of spacers 13. The rotor 12 is in this case driven via a gear disc 15. FIG. 5 shows the arrangement of FIG. 4 in the assembled state.

The arrangement of FIGS. 4 and 5 shows that a measurement takes place of the transmitted light which is emitted by the light-emitting diode 8 and is received by a photodiode 16. Instead of this, a measurement using reflected light may also take place.

As mentioned, the measurement is started by filling the holding spaces 2 with reagents and the reaction chambers 4 with body fluids. The arrangement of cuvettes 1 can then be put onto the rotor 12 and initially rotated once through 360°, so that it is possible to identify which cuvettes contain fluids that are to be analysed. Since the incubator 7 and the rotor 12 are warmed, incubation then takes place to the desired temperature, usually 37° C., which is achieved in about two minutes. The arrangement of cuvettes 1 is then set in rapid rotation so that, because of the centrifugal force, the reagents pass from the holding space 2 into the reaction chamber 4, where they are mixed by the stirrer 5 which is moved by the magnet 9. The measurement then takes place at the measuring stations 8/16 and 10.

FIG. 6 schematically shows the movement of the spherical stirrer 5 during the rotation of the arrangement of cuvettes, specifically to the right radially from the outside and to the left in the circumferential direction, that is to say to the right in the viewing direction of the arrow R of FIG. 2 and to the left in the direction of the arrow L of FIG. 2.

As can be seen in FIG. 6, the bottom of the cuvettes has concave curves with different curvatures in the circumferential direction and in the radial direction. The ball 5 is initially found at the lowermost location in the middle of the reaction chamber. The curves are in this case designed to be so great that the ball can be moved only insignificantly away from this lowermost location by the centrifugal force. However, this does happen when, as shown in FIG. 6 at A, the corresponding cuvette 1 approaches the magnet 9 In this case, as shown at B and C in FIG. 6, the ball is attracted by the magnet 9 and moves upwards on the curve, and then commences a circular movement shown in FIGS. B-F. In this case, at the position of D in FIG. 6, the ball has left the lower curve and can move on the straight wall, so that it moves outwards because of the centrifugal force and enters the proximity of the sensor 10, where its presence can be detected. Subsequently, the ball then moves back down until the cycle begins again. If the fluid is coagulated, however, then the ball remains in the position of C in FIG. 6, and it is no longer detected by the sensor 10, so that it is possible to identify the coagulated state, if this is not done using optical methods.

As can be seen from the Figs, all the chambers and holding spaces are open at the top. The arrangement of cuvettes can therefore be formed in a single injection-moulding process. This is facilitated if the chambers and holding spaces widen slightly upwards. This also makes it possible to stack the cuvette arrangements.

1. Device for analysing body fluids, having an arrangement of cuvettes (1) which can be fitted into the device, into which the body fluid to be analysed and a reagent can be introduced separately and can be brought together into a reaction chamber (4) after an incubation time has elapsed, and having at least one measuring station (8, 10), wherein the cuvettes (1) are connected to one another in a circular arrangement, and respectively have a holding space (2) with a bottom (3) rising radially outwards and a reaction chamber arranged radially outwards from the holding space (2), and the cuvette arrangement can be rotated about its axis with the aid of a rotor (12), characterized in that the holding space (2) is intended for the reagent, in that the reaction chambers extend in the axial direction to a greater depth than the holding space (2), and in that a stirrer (5) made of magnetically attractable material is arranged in each reaction chamber, and can be set in notion by a magnet (9) which is arranged on the device at the circumference of the fitted arrangement of cuvettes (1).

2. Device according to claim 1, characterized in that a plurality of measuring stations (8/16, 10) are provided.

3. Device according to claim 1 or 2, characterized in that at least one measuring station (8/16) is intended for optical detection.

4. Device according to one of claims 1 to 3, characterized in that measuring stations (8/16, 10) for optical transmission and/or reflection measurements are provided.

5. Device according to one of claims 1 to 4, characterized in that a measuring station (10) is provided which detects the position of the magnetically attractable body.

6. Device according to one of claims 1 to 5, characterized in that the magnetically attractable stirrer (5) is a ball.

7. Method for operating a device according to one of claims 1 to 6, characterized in that at least one of the cuvettes is filled with reagent and body fluid, the cuvette arrangement is fitted into the device and, with the aid of the rotor, a rotation through at least 360° is carried out in order to identify samples which have been measured previously and/or samples which are to be measured, the cuvettes with the reagents and samples are incubated, the reagents are taken into the reaction chambers by subsequent rapid rotation of the cuvette arrangement, and the optical and/or magnetic measurements are subsequently carried out 8. Cuvette arrangement for analysing body fluids, having a plurality of cuvettes (1), characterized in that the cuvettes (1) are connected to one another in a circular arrangement, and respectively have a holding space (2) for the reagent with a bottom (3) rising radially outwards, and the reaction chamber (4) is arranged radially outwards from the holding space (2) and extends in the axial direction to a greater depth than the holding space (2).
